(19) United States
(12) Patent Application Publication
(10) Pub. No.: US 2010/0085659 A1
(43) Pub. Date: Apr. 8, 2010

(54) Information storage devices using magnetic domain wall motion

(75) Inventors: Sug-bong Choe, Seoul (KR); Kyoung-Woong Moon, Seoul (KR); Jae-chul Lee, Namdong-gu (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/588,066

(22) Filed: Oct. 2, 2009

(30) Foreign Application Priority Data
Oct. 8, 2008 (KR) 10-2008-0098866
May 26, 2009 (KR) 10-2009-0046080

(51) Int. Cl. G11B 21/02

(52) U.S. Cl. 360/77.01; G9B/21.003

(57) ABSTRACT

An information storage device includes a magnetic track and a pinning element for pinning the magnetic domain wall. The magnetic track includes a plurality of magnetic domains and a magnetic domain wall arranged between each pair of adjacent magnetic domains. The pinning element is configured to apply a magnetic field to pin the magnetic domain wall to the magnetic track. The magnetic field may have the same magnetization direction as the magnetic domain wall.

### CROSS-REFERENCE TO RELATED APPLICATIONS

This application claims priority under 35 U.S.C. §119 to Korean Patent Application No. 10-2008-0098866, filed on Oct. 8, 2008, and Korean Patent Application No. 10-2009-0046080, filed on May 26, 2009, in the Korean Intellectual Property Office. The entire contents of each of these applications are incorporated herein by reference.

### BACKGROUND

1. Field

One or more example embodiments relate to information storage devices using magnetic domain wall motion.

2. Description Of The Related Art

Related art non-volatile information storage devices retain recorded information even when power is cut off. Example related art non-volatile information storage devices include hard disk drives (HDDs), non-volatile random access memories (RAMs), etc.

In general, a rotating mechanical device of a related art HDD may wear down and fail, thereby causing relatively low reliability.

A representative example of non-volatile RAM is flash memory. Although a related art flash memory device does not use a rotating mechanical device, flash memory devices have lower reading and writing speeds, shorter lifetimes, and smaller storage capacity than HDDs. Also, related art flash memory devices have relatively high manufacturing costs.

Another type of information storage device uses motion of a magnetic domain wall of a magnetic material. A magnetic domain is a minute magnetic region in which magnetic moments are arranged in one direction in a ferromagnetic material. A magnetic domain wall is a border region between magnetic domains having different magnetization directions. A magnetic domain wall formed between magnetic domains moves in response to a current supplied to a magnetic track. It is expected that an information storage device having a relatively large storage capacity without using a rotating mechanical device may be realized by using magnetic domain wall motion.

An example core technology of a related art information storage device using magnetic domain wall motion is a technology for pinning a magnetic domain wall. A magnetic domain wall that is moved in response to a current supplied to a magnetic track should be pinned at a desired location of the magnetic track. Thus, the magnetic domain wall is moved in bit units.

In the related art, notches are used to pin a magnetic domain wall. In more detail, notches formed on a magnetic track and are used as pinning sites of a magnetic domain wall. However, various problems may occur when notches are used. For example, a current may be concentrated near notches of a magnetic track so as to generate heat. As such, reliability of information recorded on the magnetic track is reduced and the magnetic track itself may be damaged. Also, it is relatively difficult to form minute notches on a magnetic track, which has a thickness or a width of about several nanometers. Moreover, forming minute notches at equal intervals to have uniform sizes and shapes is relatively difficult. If intervals, sizes, and shapes of notches are not uniform, the strength of a magnetic field for pinning a magnetic domain wall (e.g., a pinning magnetic field) varies accordingly. As a result, device characteristics may become non-uniform.

### SUMMARY

One or more example embodiments provide methods of pinning a magnetic domain wall without forming notches, and information storage devices using the method.

At least one example embodiment provides an information storage device using magnetic domain wall motion. According to at least this example embodiment, the information storage device includes a magnetic track and a pinning element. The magnetic track includes a plurality of magnetic domains and a magnetic domain wall between each pair of adjacent magnetic domains. The pinning element is separated from the magnetic track and configured to pin the magnetic domain wall.

According to at least some example embodiments, the pinning element may apply a magnetic field for pinning the magnetic domain wall at a position within the magnetic track. The magnetization direction of the magnetic field may be the same as the magnetization direction of the magnetic domain wall. The pinning element may be a magnetic layer pattern. At least a portion of the magnetic layer pattern may be magnetized in the magnetization direction of the magnetic domain wall.

According to at least some example embodiments, the magnetic layer pattern may extend in a direction perpendicular or substantially perpendicular to the magnetic track. An end of the magnetic layer pattern, which faces the magnetic track, may have a peaked or pointed shape. The magnetic layer pattern may have a symmetric or asymmetric structure. The magnetic layer pattern may be a nanoscale pattern and a distance between the magnetic layer pattern and the magnetic track may be several to several tens of nanometers.

According to at least some example embodiments, the magnetic layer pattern may include at least one selected from the group including cobalt (Co), nickel (Ni), iron (Fe), etc.

The magnetic layer pattern and the magnetic track may be formed of the same, substantially the same or different materials. The magnetic track may have in-plane magnetic anisotropy or perpendicular magnetic anisotropy. The magnetic layer pattern may have in-plane magnetic anisotropy or perpendicular magnetic anisotropy.

The magnetic track and the pinning element may be formed on the same or substantially the same plane. In this example, the pinning element may be formed at one or two sides of the magnetic track.

The magnetic track and the pinning element may be stacked in a perpendicular or substantially perpendicular direction. In this example, the pinning element may be formed at one or more of upper and lower sides of the magnetic track.

A plurality of the pinning elements may be formed at equal or substantially equal intervals at one or more sides of the magnetic track.

### BRIEF DESCRIPTION OF THE DRAWINGS

Example embodiments will become apparent and more readily appreciated from the following description of the accompanying drawings of which:

FIG. 1A is a plan view of an information storage device using motion of a magnetic domain wall according to an example embodiment;

FIG. 1B is a graph showing variations in energy of a magnetic track illustrated in FIG. 1A according to the location of the magnetic domain wall thereof;

FIG. 2 is a graph showing variations in strength of a magnetic field applied from a pinning element to a magnetic track illustrated in FIG. 1A according to the distance between the magnetic track and the pinning element;

FIG. 3 is a plan view of an information storage device using motion of a magnetic domain wall according to another example embodiment;

FIG. 4 is a cross-sectional view of an information storage device using motion of a magnetic domain wall according to another example embodiment;

FIGS. 5A through 5E are diagrams showing various shapes of a pinning element included in an information storage device according to an example embodiment; and

FIG. 6 is a plan view of an information storage device using motion of magnetic domain walls according to another example embodiment.

### DETAILED DESCRIPTION

Various example embodiments will now be described more fully with reference to the accompanying drawings in which some example embodiments are shown.

Detailed illustrative example embodiments are disclosed herein. However, specific structural and functional details disclosed herein are merely representative for purposes of describing example embodiments. Example embodiments, however, may be embodied in many alternate forms and should not be construed as limited to only the example embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items.

It will be understood that when an element or layer is referred to as being “formed on,” another element or layer, it can be directly or indirectly formed on the other element or layer. That is, for example, intervening elements or layers may be present. In contrast, when an element or layer is referred to as being “directly formed on,” to another element, there are no intervening elements or layers present. Other words used to describe the relationship between elements or layers should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

In the drawings, the thicknesses of layers and regions are exaggerated for clarity. Like reference numerals in the drawings denote like elements.

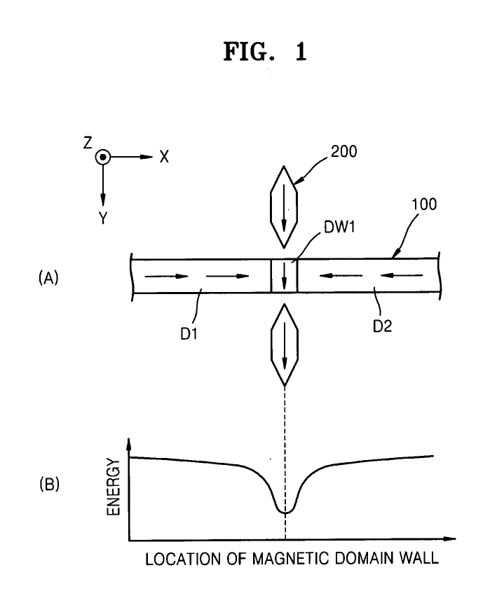

FIG. 1A is a plan view of an information storage device according to an example embodiment.

Referring to the example embodiment shown in FIG. 1A, a magnetic track 100 extends in a desired direction (e.g., an X axis direction). The magnetic track 100 includes a plurality of magnetic domains (e.g., first and second magnetic domains D1 and D2). A magnetic domain wall DW1 is formed between the first and second magnetic domains D1 and D2. The first and second magnetic domains D1 and D2 may be magnetized in directions opposite to each other. The magnetic domain wall DW1 may be a border region between the first and second magnetic domains D1 and D2. Although only two magnetic domains (e.g., the first and second magnetic domains D1 and D2) are illustrated in FIG. 1A, the magnetic track 100 may include three or more magnetic domains. In this case, a magnetic domain wall is formed between each pair of adjacent or neighboring magnetic domains.

Still referring to FIG. 1A, the magnetic track 100 may be formed of a material and a structure having in-plane magnetic anisotropy. In this example, the first and second magnetic domains D1 and D2 of the magnetic track 100 may have magnetization directions parallel to a length direction of the magnetic track 100. In FIG. 1A, the first magnetic domain D1 is magnetized in the X axis direction, whereas the second magnetic domain D2 is magnetized in an inverse X axis direction. The magnetic domain wall DW1 is magnetized in a Y axis direction. The first and second magnetic domains D1 and D2 may correspond to information ‘0’ and ‘1’, respectively. Alternatively, however, the first and second magnetic domains D1 and D2 may correspond to information ‘1’ and ‘0’, respectively. The magnetization directions of the first and second magnetic domains D1 and D2 and the magnetic domain wall DW1 may be changed. The magnetic track 100 may also have perpendicular magnetic anisotropy.

Still referring to FIG. 1A, the information storage device further includes at least one pinning element 200 configured to pin the magnetic domain wall DW1 at a position within the magnetic track 100. According to at least some example embodiments, a pinning element 200 may be formed at one or more sides of the magnetic track 100, but separate from the magnetic track 100. In the example shown in FIG. 1A, a pinning element 200 is formed at two sides of the magnetic track 100. In more detail, pinning elements 200 may be formed at opposing sides of the magnetic track 100. The pinning elements 200 formed at opposing sides of the magnetic track 100 may be formed on the same or substantially the same axis. The pinning element 200 may apply a magnetic field for pinning the magnetic domain wall DW1 to the magnetic track 100. The direction of the magnetic field may be the same or substantially the same as the magnetization direction of the magnetic domain wall DW1.

According to at least one example embodiment, the pinning element 200 may be a magnetic layer pattern configured to generate the magnetic field. In this example, the pinning element 200 extends in a direction perpendicular or substantially perpendicular to the magnetic track 100. The pinning element 200 may have the same magnetization direction as the magnetic domain wall DW1. In this example embodiment, the pinning element 200 has an in-plane magnetic anisotropy. The pinning element 200 may have a length in the Y axis direction that is greater than the length in the X axis direction (hereinafter referred to as the width). In a more specific example, the pinning element 200 may have a width of about several ten to several hundred nanometers and a length several times greater than the width. The pinning element 200 may have a thickness that is less than several tens of nanometers. Such dimensioning of the pinning element 200 may be referred to as a nanoscale. When the pinning element 200 has in-plane magnetic anisotropy, the pinning element 200 may have a magnetic easy axis in a length direction of the pinning element 200 (e.g., the Y axis direction). Thus, the pinning element 200 may be magnetized in a direction parallel to the Y axis direction.

One of two ends of the pinning element 200, which face the magnetic track 100, may have a peaked shape. The peaked or pointed end of the pinning element 200 may be more easily magnetized in a direction parallel to the Y axis direction because of the shape thereof. Also, in this example, the width of the magnetic field applied by the pinning element 200 to the magnetic track 100 may be narrowed. The other of the two ends of the pinning element 200, which is away from the magnetic track 100, may also have a peaked or pointed shape. However, in some cases, the other end of the pinning element 200 may not have a peaked shape. Thus, the pinning element 200 may have a symmetric or asymmetric structure, for example, in the Y axis direction. The pinning element 200 is not limited to the shape illustrated in FIG. 1A and may be variously changed. The distance between the pinning element 200 and the magnetic track 100 may be about several to several tens of nanometers.

Although not shown in FIG. 1A, at least one end of the magnetic track 100 may be connected to a current supply circuit or unit (referred to herein as current supply unit). The current supply unit is configured to supply a current to the magnetic track 100 for moving the magnetic domain wall DW1.

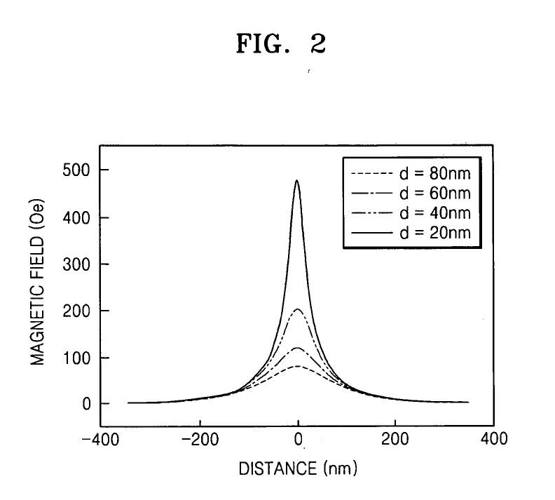

FIG. 2 is a graph showing a magnetic field generated by the pinning element 200 illustrated in FIG. 1A. FIG. 2 is a graph showing variations in strength of a magnetic field applied from the pinning element 200 to the magnetic track 100 illustrated in FIG. 1A according to a distance ‘d’ between the magnetic track 100 and the pinning element 200. In this example, the magnetic field is a magnetic field of Y axis components applied from the pinning element 200 to the magnetic track 100. In the graph of FIG. 2, the X axis represents the location of the magnetic track 100 in an X axis direction. A site at which X=0 is a site Where the magnetic track 100 is closest to the pinning element 200.

Referring to FIG. 2, the magnetic field is applied from the pinning element 200 to the magnetic track 100 in a direction perpendicular to the magnetic track 100. In this case, the strength of the magnetic field is about several ten to several hundred oersteds. As further shown in FIG. 2, as the magnetic track 100 moves closer to the pinning element 200, the strength of the magnetic field applied to the magnetic track 100 increases.

Referring back to FIG. 1A, if the magnetic domain wall DW1 is located in the magnetic field generated by the pinning element 200, the energy of the magnetic track 100 may be more stable. Thus, the magnetic domain wall DW1 that is moved due to a current supplied to the magnetic track 100 may be pinned at a site where the pinning element 200 is located. As such, according to at least this example embodiment, the magnetic domain wall DW1 may be pinned more easily without forming notches by using a magnetic layer pattern for generating a magnetic field (e.g., a stray field) as the pinning element 200. Thus, various problems caused by notches may be suppressed and/or prevented.

FIG. 1B is a graph showing variations in energy of the magnetic track 100 illustrated in FIG. 1A according to the location of the magnetic domain wall DW1.

Referring to FIG. 1B, when the magnetic domain wall DW1 is closest to (e.g., about 20 nm from) the pinning element 200 illustrated in FIG. 1A, the energy of the magnetic track 100 is least.

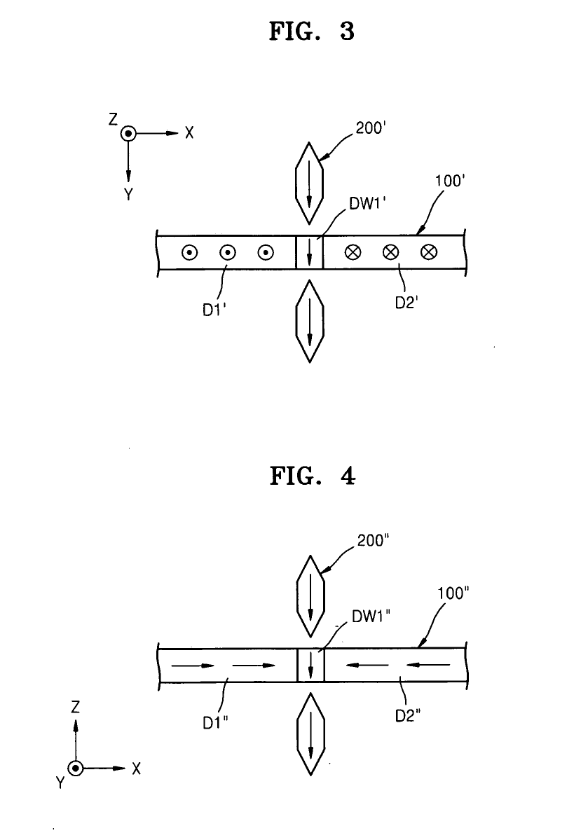

FIG. 3 is a plan view of an information storage device using magnetic domain wall motion according to another example embodiment. FIG. 3 shows a case when a magnetic track 100′ has perpendicular magnetic anisotropy and a pinning element 200′ has in-plane magnetic anisotropy. However, this need not be the case.

Referring to FIG. 3, the magnetic track 100′ may have perpendicular magnetic anisotropy. In this case, a first magnetic domain D1′ of the magnetic track 100′ is magnetized in a Z axis direction, whereas a second magnetic domain D2′ of the magnetic track 100′ is magnetized in an inverse Z axis direction. In FIG. 3, ⊙ and [symbol] marked in the first and second magnetic domains D1′ and D2′ represent respective magnetization directions of the first and second magnetic domains D1′ and D2′. The magnetic domain wall DW1′ has a magnetization direction parallel to a Y axis direction. According to at least this example embodiment, the pinning element 200′ may be formed at one or more sides (e.g., two sides of the magnetic track 100′). In the example shown in FIG. 2, the pinning elements 200′ are formed at opposite sides of the magnetic track 100′. The pinning elements 200′ may have the same magnetization direction as the magnetic domain wall DW1′. Each pinning element 200′ may be similar or substantially similar to the pinning element(s) 200 illustrated in FIG. 1A, and thus, a detailed description thereof will not be provided here.

Like FIG. 1A, in FIG. 3 the magnetic domain wall DW1′ may be pinned by a magnetic field generated from the pinning element 200′.

FIG. 4 is a cross-sectional view of an information storage device using magnetic domain wall motion according to another example embodiment. FIG. 4 shows a case in which a magnetic track 100″ has in-plane magnetic anisotropy and a pinning element 200″ has perpendicular magnetic anisotropy. While the magnetic track 100 and the pinning element 200 illustrated in FIG. 1A are formed on the same plane and the magnetic track 100′ and the pinning element 200′ illustrated in FIG. 3 are formed on the same plane, the magnetic rack 100″ and the pinning element 200″ illustrated in FIG. 4 are stacked in a perpendicular or substantially perpendicular direction.

Referring to FIG. 4, first and second magnetic domains D1″ and D2″ of the magnetic track 100″ may be magnetized in an X axis direction and an inverse X axis direction, respectively. The magnetic domain wall DW1″ may have a magnetization direction parallel to a Z axis direction. The magnetic track 100″ is different from the magnetic track 100 in that the magnetization direction of the magnetic domain wall DW1″ is different from that of the magnetic domain wall DW1 illustrated in FIG. 1A. When the magnetic domain wall DW″ has a magnetization direction parallel to the Z axis direction as shown in FIG. 4, the pinning element 200″ may be formed at one or more of upper and lower sides of the magnetic track 100. In this example, the pinning element 200″ may have a magnetic easy axis parallel to the Z axis direction. The pinning element 200″ may also have perpendicular magnetic anisotropy. When the pinning element 200″ has perpendicular magnetic anisotropy, the magnetic easy axis may be determined according to the crystal structure of the pinning element 200″. Thus, the shape of ends of the pinning element 200″ may not have a peaked or pointed shape.

Like FIGS. 1A and 3, in FIG. 4 the magnetic domain wall DW1″ of the magnetic track 100″ may be pinned by a magnetic field generated by the pinning element 200″.

In FIGS. 1A, 3, and 4, the magnetic tracks 100, 100′, and 100″ and the pinning elements 200, 200′, and 200″ may be formed of a magnetic material containing at least one selected from the group including cobalt (Co), nickel (Ni), iron (Fe), etc. The magnetic material may further include another element in addition to Co, Ni, and Fe. The magnetic tracks 100, 100′, and 100″ and the pinning elements 200, 200′, and 200″ may be formed of the same, substantially the same or different material(s). For example, at least one of the magnetic tracks 100, 100′, and 100″ and the pinning elements 200, 200′, and 200″ may be formed of a soft magnetic material having in-plane magnetic anisotropy or a ferromagnetic material having perpendicular magnetic anisotropy.

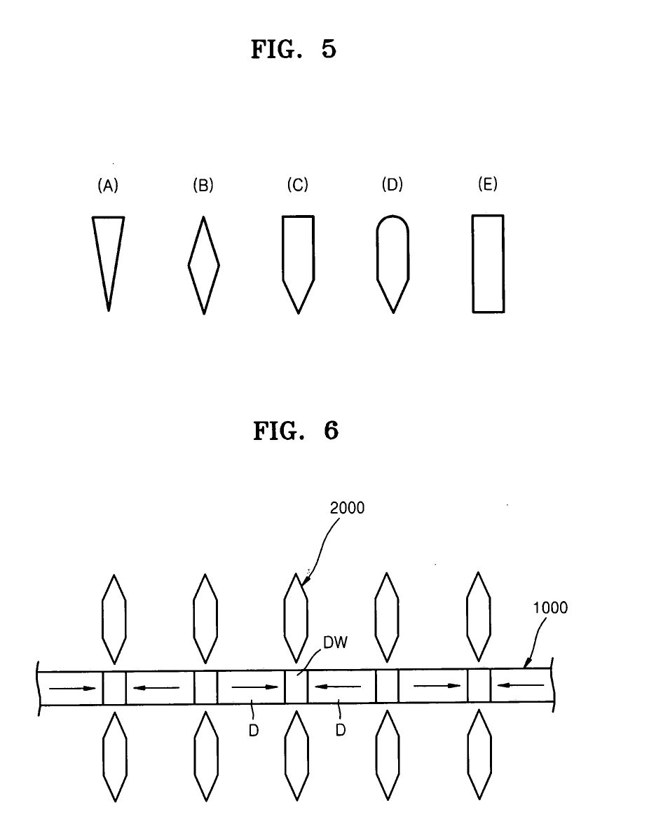

The pinning elements 200, 200′, and 200″ may have various shapes. Examples of the various shapes are illustrated in FIGS. 5A through 5E.

FIG. 5A shows a pinning element having a triangular shape. FIG. 5B shows a pinning element having a diamond shape, FIG. 5C shows a pinning element having a pentagonal shape with one peaked end. FIG. 5D shows a pinning element having a shape with one peaked end and a circular end. FIG. 5E shows a pinning element having a rectangular shape.

In FIGS. 1A, 3, and 4, each of the magnetic tracks 100, 100′, and 100″ has one magnetic domain wall DW1, DW1′, or DW1″ and corresponds to a pair of pinning elements 200, 200′, or 200″. However, two or more magnetic domain walls DW1, DW1′, or DW1″ may be formed, and thus, the number of pinning elements 200, 200′, or 200″ may be increased accordingly. For example, an information storage device may be structured as shown in FIG. 6.

FIG. 6 is a plan view of an information storage device using motion of magnetic domain walls according to another example embodiment.

Referring to FIG. 6, a magnetic track 1000 according to at least this example embodiment includes a plurality of magnetic domains D and a plurality of magnetic domain walls DW. Each magnetic domain wall is arranged between a corresponding pair of adjacent magnetic domains D. A plurality of pinning elements 2000 may be formed at equal or substantially equal intervals at one side of the magnetic track 1000. Intervals between the pinning elements 2000 may be the same or substantially the same as those between the magnetic domain walls DW. A plurality of pinning elements 2000 may also be formed at the other (e.g., opposite) side of the magnetic track 1000. The pinning elements 2000 at the other side of the magnetic track 1000 may correspond one-to-one to the pinning elements 2000 at the one side of the magnetic track 1000. The pinning elements 2000 may be formed together with the magnetic track 1000. In this example, a photolithography process or a fine patterning process such as an electronic beam (e-beam) lithography process may be performed. If the pinning elements 2000 are relatively small and the intervals between the pinning elements 2000 are relatively small, a fine patterning process such as an e-beam lithography process may be used. In this example, the pinning elements 2000 may be formed by using a process other than the above-mentioned example processes.

In addition, although not shown in FIGS. 1A, 3, 4, and 6, each of the information storage devices illustrated in FIGS. 1A, 3, 4, and 6 may further include a write unit for recording data on the magnetic track 100, 100′, 100″, or 1000 and a read unit for reproducing the recorded data. A write/read unit having both of recording (writing) and reproduction (reading) functions may be included instead of the write unit and the read unit. The write unit may be an element for recording data using, for example, spin transfer torque or an external magnetic field. If the write unit is an element for recording data using spin transfer torque, the write unit may have, for example, the structure of a tunnel magneto resistance (TMR) or giant magneto resistance (GMR) element. The read unit may be a sensor for reproducing data using a TMR or GMR effect. The write/read unit may be an integral element that records data like the write unit and reproduces data like the read unit. The write unit, the read unit, and the write/read unit are optional and the above-described structures and the operational principals thereof may be variously changed.

It should be understood that the example embodiments described herein should be considered in a descriptive sense only and not for purposes of limitation. For example, it will be understood by one of ordinary skill in the art that the example embodiments of the present invention may also be applied to any other device using motion of a magnetic domain wall, for example, a logic device using motion of a magnetic domain wall. Also, the structures of the information storage devices illustrated in FIGS. 1A, 3, 4, and 6 may be variously changed. For example, in FIGS. 1A, 3, 4, and 6, the pinning elements 200, 200′, 200″, and 2000 may be formed as a component other than a magnetic layer pattern and may be formed at one side, instead of two sides, of the magnetic tracks 100, 100′, 100″, and 1000. Furthermore, the shapes of the magnetic tracks 100, 100′, 100″, and 1000 may be variously changed. Thus, descriptions of features or aspects within each example embodiment should typically be considered as available for other similar features or aspects in other example embodiments.

What is claimed is:

1. An information storage device using magnetic domain wall motion, the device comprising:
a magnetic track including a plurality of magnetic domains and a magnetic domain wall between each pair of adjacent magnetic domains; and
at least one pinning element separated from the magnetic track and configured to pin the magnetic domain wall.

2. The device of claim 1, wherein the at least one pinning element applies a magnetic field to pin the magnetic domain wall to the magnetic track, and wherein a direction of the magnetic field is the same as the magnetization direction of the magnetic domain wall.

3. The device of claim 2, wherein the at least one pinning element is a magnetic layer pattern, and wherein at least a portion of the magnetic layer pattern is magnetized in the same magnetization direction as the magnetic domain wall.

4. The device of claim 3, wherein the magnetic layer pattern extends in a direction perpendicular to the magnetic track.

5. The device of claim 4, wherein an end of the magnetic layer pattern, which faces the magnetic track, has a peaked shape.

6. The device of claim 4, wherein the magnetic layer pattern has one of a symmetric and asymmetric structure.

7. The device of claim 3, wherein the magnetic layer pattern is a nanoscale pattern.

8. The device of claim 3, wherein a distance between the magnetic layer pattern and the magnetic track is several to several tens of nanometers.

9. The device of claim 3, wherein the magnetic layer pattern includes at least one selected from the group including cobalt (Co), nickel (Ni), and iron (Fe).

10. The device of claim 3, wherein the magnetic layer pattern and the magnetic track are formed of the same material.

11. The device of claim 3, wherein the magnetic layer pattern and the magnetic track are formed of different materials.

12. The device of claim 1, wherein the magnetic track and the at least one pinning element are formed on the same plane.

13. The device of claim 12, wherein the at least one pinning element is formed at one or more sides of the magnetic track.

14. The device of claim 1, wherein the magnetic track and the at least one pinning element are stacked in a perpendicular direction.

15. The device of claim 14, wherein the at least one pinning element is formed at one or more sides of upper and lower sides of the magnetic track.

16. The device of claim 1, wherein a plurality of the pinning elements are formed at equal intervals at one or more sides of the magnetic track.
